(19) United States
(12) Patent Application Publication
(10) Pub. No.: US 2017/0043347 A1
(43) Pub. Date: Feb. 16, 2017

(54) WEAR RESISTANT COMPONENT AND DEVICE FOR MECHANICAL DECOMPOSITION OF A MATERIAL PROVIDED WITH SUCH A COMPONENT

(71) Applicant: SANDVIK INTELECTUAL PROPERTY AB, Sandviken (SE)

(72) Inventors: Tomas BERGLUND, Falun (SE); Udo FISCHER, Lindlar (DE)

(21) Appl. No.: 15/307,085

(22) PCT Filed: Apr. 29, 2015
(86) PCT No.: PCT/EP2015/059286

§ 371 Date: Oct. 27, 2016

(30) Foreign Application Priority Data
Apr. 30, 2014 (EP) 14166690.9

(51) Int. Cl. B02C 4/30; B22F 1/00; C22C 38/38; C22C 38/36; C22C 38/34; C22C 38/30; C22C 38/24; C22C 38/22; C22C 38/04; C22C 38/02; C22C 19/07; C22C 19/05; C22C 29/08; B02C 13/28; B22F 3/15

(52) U.S. Cl. CPC B02C 4/305; B22F 3/15; B22F 1/0003; C22C 38/38; C22C 38/36; C22C 38/34; C22C 38/30; C22C 38/24; C22C 38/22; C22C 38/04; C22C 38/02; C22C 19/07; C22C 19/058; C22C 29/08; B02C 13/28; B22F 2301/15; B22F 2301/35; B22F 2302/10; B02C 2210/02

(57) ABSTRACT

A wear resistant component for comminution of particulate material includes a steel body and a leading portion of cemented carbide attached to a front portion of the steel body. The wear resistant component includes a wear resistant coating of a metal matrix composite attached to at least one face of the steel body connected to the leading portion.

### TECHNICAL FIELD

The present disclosure relates to a wear resistant component for comminution, such as crushing, milling, pulverization, of particulate material, comprising a steel body and a leading portion of cemented carbide attached to a front portion of said steel body.

The present disclose also relates to a device for mechanical decomposition of material provided with such a wear resistant component.

### BACKGROUND OF THE DISCLOSURE

In connection to the crushing of particulate matter, such as in the case of crushing of oil sand related matter by means of crushers, wear resistant components of different design may be used. According to one solution, teeth of a wear resistant material are attached on the outer peripheral surface of pairs of rotating drums that rotate in opposite direction while the particulate matter is introduced from above into a gap between said drums. This is, for example, a principle used in so called secondary and tertiary crushers for the crushing of particulate matter in an oil sand treatment plant in which bitumen is extracted from oil sand.

The wear resistant components formed by said teeth may comprise a steel body onto a front portion of which there is attached a leading portion of cemented carbide. The leading portion is responsible for most of the crushing by being the foremost and first portion of the component to hit and thereby affect the matter to be crushed. Apart from the front portion there may also be other faces on the steel body that need to be protected from wear. A wear resistant coating should be applied to such faces. The coating needs to be hard enough to withstand the forces that it is subjected to when hitting the matter to be crushed and also be wear resistant in the sense that it should be resistant to erosion, corrosion and abrasion caused by matter that is being or has been crushed and is passed by the wear resistant component. According to prior art such a coating may, likewise to the leading portion, comprise cemented carbide, such as tungsten carbide with a cobalt and/or nickel based binder. Accordingly, at least parts of said face or faces are covered with the same kind of material as the material that forms the leading portion.

However, it is technically difficult and time-consuming to apply a coating of cemented carbide onto a steel body by contemporary technique. Preferably, the cemented carbide needs to be provided as one or more bodies that are attached mechanically to the steel body, for example by bracing. Therefore an alternative to prior art designs of wear resistant components aimed for the crushing of particulate matter would be of great value for at least some application s within the technical field that includes crushing of particulate matter.

It is an aspect of the present disclosure to present a wear resistant component suitable for applications such as crushing of particulate matter, wherein said component is of a design that favours efficient production thereof. In particular, the wear resistant component should be of a design that promotes production of at least one or more parts of said component by means of a Hot Isostatic Pressure process, HIP.

### SUMMARY OF THE DISCLOSURE

The present disclosure therefore relates to a wear resistant component for comminution of particulate material comprising a steel body and a leading portion of a cemented carbide attached to a front portion of said steel body, wherein said component comprises a wear resistant coating of a metal matrix composite attached to at least one face of said steel body in connection to said leading portion characterised in that the wear resistant coating has been formed by consolidation of a powder mixture by means of Hot Isostatic Pressing (HIP). The HIP process will provide for a better adhesion between the wear resistant coating and the steel body. In the wear resistant component as defined hereinabove or hereinafter the leading portion of cemented carbide is metallurgically bonded to a front portion of said steel body and the said component comprises a wear resistant coating of a metal matrix composite of said component is also metallurgically bonded to at least one face of the steel body.

Additionally, the obtained wear resistant coating will have a pore-free microstructure free from signs of molten phases therein.

The leading portion may be a separate part attached mechanically to the front portion of the steel body by means of diffusion bonding as a result of a HIP process by means of which both the wear resistant coating and the leading portion is attached to the steel body.

When the wear resistant component is mounted on a crusher or the like and the crusher or the like is operating, the leading portion is the foremost portion of the wear resistant component to hit the matter to be crushed. A metal matrix composite is suitable as a coating material on one or more faces on the steel body since it can be attached thereto in a HIP process in which a powder mixture comprising the constituents of said metal matrix composite is positioned on such a face and consolidated by means of the heat and pressure applied during said HIP process. The metal matrix composite will thus adhere metallurgically to the steel body. The metal matrix composite may consists of 30-70 vol. % particles of tungsten carbide and 30-70 vol. % matrix of a metal-based alloy. The leading portion may be attached directly onto the front portion of the steel body or onto a coating of said metal matrix composite attached to the front portion of the steel body.

According to one embodiment, said metal matrix composite is any of a nickel-based metal matrix composite, a cobalt-based metal matrix composite or an iron-based metal matrix composite. Such metal matrix composites are particularly suitable for HIP processes and will also result in a coating with high wear resistance. The metal matrix composite may also comprise particles of tungsten carbide in a matrix of a nickel-based alloy or a cobalt-based alloy or an iron-based alloy. The particles of tungsten carbide may be distributed as discrete non-interconnecting particles in the matrix of the metal-based alloy. According to one alternative, the majority of the tungsten carbide particles are distributed as discrete non-interconnecting particles in the matrix of the metal-based alloy. In a component wherein the wear resistant coating has been produced by means of a HIP process, the homogenous distribution of discrete, non-interconnecting tungsten particles in a metal-based alloy matrix will yield ductility and a uniform hardness throughout the component and hence provide the component with a high wear resistance and strength.

According to one embodiment, said metal matrix composite comprises particles of tungsten carbide and a matrix of a nickel-based alloy, wherein the nickel-based alloy consists of: 0-1.0 wt % C; 5-14.0 wt % Cr; 0.5-4.5 wt % Si; 1.25-3.0 wt % B; 1.0-4.5 wt % Fe; balance Ni and unavoidable impurities. This nickel-based alloy is strong and ductile and therefore very suitable as matrix material in abrasive resistant applications.

Carbon forms together with chromium and iron, small metal rich carbides, for example M23C6 and M7C3 that are precipitated in the ductile nickel-based alloy matrix. The precipitated carbides strengthen the matrix by blocking dislocations from propagating. According to the present disclosure, the powder of the nickel-based alloy used for attachment of the wear resistant coating comprises at least 0.25 wt % carbon in order to ensure sufficient precipitation of metal rich carbides. However, too much carbon may reduce the ductility of the nickel-based alloy matrix and carbon should therefore be limited to 1.0 wt %. Thus, the nickel-based alloy preferably comprises of from 0.25-1.0 wt % carbon. For example, the amount of carbon is of from 0.25-0.35 or 0.5-0.75 wt %.

Chromium is important for corrosion resistance and to ensure the precipitation of chromium rich carbides and chromium rich borides. Chromium is therefore included in the nickel-based alloy matrix in an amount of at least 5 wt %. However, chromium is a strong carbide former and high amounts of chromium could therefore lead to increased dissolving of tungsten carbide particles. Chromium should therefore be limited to 14 wt %. Thus, the nickel-based alloy preferably comprises 5-14 wt % chromium. For example, the amount of chromium is 5.0-9.5 wt % or 11-14 wt %. In certain applications, it is desirable to entirely avoid dissolving of the tungsten carbide particles. In that case, the content of chromium could be <1.0 wt % in the nickel-based alloy matrix.

Silicon is used in the manufacturing process of nickel-based alloy powder and may therefore be present in the nickel-based alloy matrix, typically in an amount of at least 0.5 wt % for example, 2.5-3.25 wt % or 4.0-4.5 wt %. Silicon may have a stabilizing effect on tungsten rich carbides of the type M6C and the content of silicon should therefore be limited to 4.5 wt %.

Boron forms chromium rich borides, which contribute hardening and increase the wear resistance of the nickel-based alloy matrix. Boron should be present in an amount of at least 1.25 wt % to achieve a significant effect. However, the solubility of boron in nickel, which constitutes the main element in the nickel-based alloy matrix, is limited and therefore the amount of boron should not exceed 3.0 wt %. For example, the amount of boron is 1.25-1.8 wt % or 2.0-2.5 wt % or 2.5-3.0 wt %.

Iron is typically included in scrap metal from which a powder comprising the nickel-based alloy is manufactured. High amounts of iron could, however, lead to dissolving of the tungsten carbide particles and iron should therefore be limited to 4.5 wt %. For example iron is present in an amount of 1.0-2.5 wt % or 3.0-4.5 wt %.

Nickel constitutes the balance of the nickel-based alloy. Nickel is suitable as matrix material since it is a rather ductile metal and also because the solubility of carbon is low in nickel. Low solubility of carbon is an important characteristic in the matrix material in order to avoid dissolving of the tungsten particles.

According to one embodiment, the metal matrix composite comprises particles of tungsten carbide having a particle size of 105-250 μm and a matrix of diffusion bonded particles of a nickel-based alloy, wherein the particle size of the diffusion bonded particles of the nickel-based alloy is <32 μm. The tungsten carbide particles may be WC or W2C or a mixture of WC and W2C. The tungsten carbide particles may be of spherical or facetted shape. The tungsten particles will provide abrasion resistance. The size of the bonded particles of the nickel-based alloy may be determined with laser diffraction, i.e. analysis of the “halo” of diffracted light produced when a laser beam passes through a dispersion of particles in air or in liquid. The maximum particle of the nickel-based alloy is selected to 32 μm in order to ensure that the nickel-based alloy particles completely surround each of the larger tungsten carbide particles. According to alternatives, the maximum size of the nickel-based alloy particles is 30 μm, 28 μm, 26 μm, 24 μm or 22 μm. It is important that the mean size of the particles of nickel-based alloy is relatively small in comparison to the mean size of the tungsten carbide particles. This has the effect that a powder mixture comprising said particles can be blended and handled in such a way that essentially all tungsten carbide particles are individually embedded in the nickel-based alloy particles and distributed evenly in the powder mixture. Thus, essentially each tungsten particle is completely surrounded by nickel-based alloy particles. By “all” is meant that only a very small fraction of the tungsten carbide particles are in contact with each other. By the term “evenly” is meant the distance between adjacent tungsten particles approximately is constant throughout a volume of powder mixture.

The matrix of nickel-based alloy may also comprise precipitated particles of borides and carbides, wherein the particles of boride and carbide are dispersed as discrete, individual particles in the matrix and the size of the boride and carbide particles is 5-10 μm. The presence of the additional small carbides in the matrix will protect the nickel base alloy matrix from erosion and abrasion due to abrasive media hitting the MMC material at both high and low impingement angles. The precipitated particles may be iron and/or chromium rich borides and iron and/or chromium rich carbides.

According to an alternative embodiment, the metal matrix composite comprises particles of tungsten carbide and a matrix of a cobalt-based alloy, wherein the cobalt-based alloy consists of: 20-35 wt % Cr, 0-20 wt % W, 0-15 wt % Mo, 0-10 wt % Fe, 0-5 Ni wt %, 0.05-4 wt % C and balance Co. Such a component exhibits very high resistance to erosion and also to abrasive wear. The good wear resistance will depend in part on the relatively large tungsten carbide particles distributed in the component. However, without being bond to any theory, it is believed that the high wear resistance and in particular the resistance to erosive wear is a result of both the deformation hardening properties of the cobalt-based matrix and a predetermined amount of small hard carbides, i.e. in a size of 1-4 μm present in the matrix of the component. The presence of the additional small carbides in the matrix protects the cobalt base alloy matrix from erosion due to abrasive media hitting the MMC material at both high and low impingement angles. It is believed, without being bond to any theory, that the precipitated particles are formed as a result of a reaction between the tungsten carbide-particles of a first powder and the alloy elements of cobalt-based alloy powder during a HIP process.

According to a further embodiment, the cobalt-based alloy comprises 27-32 wt % Cr, 0-2 wt % W, 4-9 wt % Mo, 0-2 wt % Fe, 2-4 wt % Ni, 0,1-1.7 wt % C and balance Co. According to an alternative embodiment, the cobalt-based alloy comprises: 26-30 wt % Cr, 4-8 wt % Mo, 0-8 wt % W, 0-4 wt % Ni, 0-1.7 wt % C and balance Co. According to yet another embodiment, the cobalt-based alloy comprises: 26-29 wt % Cr, 4.5-6 wt % Mo, 2-3 wt % Ni, 0.25-0.35 wt % C and balance Co.

According to another embodiment, the metal matrix composite comprises particles of tungsten carbide and a matrix of an iron-based alloy. The iron-based alloy may comprise, in weight %: 0,5-3 wt % C; 0-30 wt % Cr; 0-3 wt % Si; 0-10 wt % Mo; 0-10 wt % W; 0-10 wt % Co; 0-15 wt % V; 0-2 wt % Mn; balance Fe and unavoidable impurities. According to a one embodiment, the iron-based alloy may comprise, in weight %: 1-2.9 wt % C; 4-25 wt % Cr; 0.3-1.5 wt % Si; 4-8 wt % Mo; 4-8 wt % W; 0-8 wt % Co; 3-15 wt % V; 0.4-1.5 wt % Mn; balance Fe and unavoidable impurities.

Typically, but not necessarily, said leading portion has a tapering cross-section and forms a tip or edge at said front portion of the steel body. According to one embodiment of the present disclosure, said steel body comprises a bottom face, and a top face opposite to said bottom face, wherein said wear resistant coating of a metal matrix composite is attached to said top face. According to the wear resistance component as defined hereinabove or hereinafter, between said bottom face and said top face, said steel body may comprise opposing lateral faces, wherein said wear resistant coating of a metal matrix composite is attached to at least parts of said lateral faces. According to an alternative embodiment, the steel body may have the shape of a truncated cone or truncated pyramid or truncated wedge, wherein said leading portion forms a nose on said truncated cone or truncated pyramid or truncated wedge and said face is a mantle surface of said truncated cone or truncated pyramid or truncated wedge, and the wear resistant coating of a metal matrix composite is attached to at least parts of said mantle surface.

According to the present disclosure, the wear resistant component may be any of an impact hammer of a mill or shredder; or a roll crusher tooth; or a crusher tooth for primary and/or secondary and/or tertiary crushers; or a wear segment for crushers; or a wear plate for crushers; or a component for a slurry handling systems; or a blade or cutter for a shredder.

The present disclosure also relates to a device for mechanical decomposition of material, characterised in that it comprises wear resistant component as defined hereinabove or hereinafter. The device may be a crusher or be any kind of crushing device used in any application in which crushing of particulate matter is envisaged, but it could as well be any of a mill or a shredder or any other kind of device for the comminution of material, typically the comminution of particulate matter, as described previously and hereinafter in this application and as realised and understood by a person skilled in the art. For example, a device for mechanical decomposition of material could. The particulate matter to be crushed could, for example, be matter obtained in connection to a mining operation or, as will be exemplified hereinafter, matter obtained in connection to the production of oil from oil sand.

The device for mechanical decomposition of material as defined hereinabove or hereinafter may comprise at least one rotary element and a further element, wherein there is a gap between the rotary element and said further element, and is characterised in that, on an outer peripheral surface of said rotary element, there is provided at least one wear resistant component as defined hereinabove or hereinafter, and that, upon rotation of the rotary element, the wear resistant component will move into said gap with its leading portion first, for the purpose of mechanically decomposing, preferably crushing, particulate matter present in said gap. The further element may be a further rotary element, and, on an outer peripheral surface of said further rotary element, there may be provided at least one wear resistant component as defined hereinabove or hereinafter, wherein, upon rotation of the further rotary element, the wear resistant component thereon will move into said gap with its leading portion first, for the purpose of mechanically decomposing, such as crushing, particulate matter present in said gap.

Further features and advantages of the present disclosure will be presented in the following detailed description of embodiments thereof.

### BRIEF DESCRIPTION OF THE DRAWINGS

Embodiments of the disclosure will now be presented with reference to the annexed drawing, on which:

FIG. 1 is a side view of a device for mechanical decomposition of material according to the disclosure,

FIG. 2 is a perspective view of a part of a device for mechanical decomposition of material according to the disclosure,

FIG. 3 is a perspective view of a first embodiment of a wear resistant component according the disclosure,

FIG. 4 is a cross section according to IV-IV in FIG. 5 of the wear resistant component in FIG. 3,

FIG. 5 is a view from above of the wear resistant component shown in FIG. 4,

FIG. 6 is a cross section according to VI-VI in FIG. 5 of the wear resistant component shown in FIG. 3,

FIG. 7 is a perspective view of a second embodiment of a wear resistant component according the disclosure,

FIG. 8 is a view from above of the wear resistant component shown in FIG. 7,

FIG. 9 is a cross section according to IX-IX in FIG. 8,

FIG. 10 is a cross section according to X-X in FIG. 8,

FIG. 11 is a perspective view of a third embodiment of a wear resistant component according to the disclosure and a holder to which the component is attached,

FIG. 12 is a view from above of the wear resistant component and holder shown in FIGS. 10-11, and

FIG. 13 is a cross section according to XIII-XIII in FIG. 12 of the wear resistant component and holder shown in FIGS. 10-12.

### DEFINITIONS

The term “comminution” as used herein is intended to include any process meaning a reduction of solid materials from one average particle size to a smaller average particle size. Example of, but not limited to“comminution” is milling, cruching, grinding and pulverization.

The term “wt %” is intended to mean “weight % and the term “vol %” is intended to mean “volume %”.

The term “metal matrix composite” (MMC) is intended to mean a material consisting of a metallic matrix containing a dispersion of ceramic material, examples of but not limiting of the shape of ceramic material are particles, fibers, whiskers which consist of carbides, nitrides, oxides and/or borides. Furthermore, the ceramic material is not a result of a chemical reaction between the alloying elements of the metallic matrix but is added to the metal matrix composite.

Cemented carbide is a MMC material usually comprising a Co or Co-alloy matrix with WC particles. The metallic matrix may also comprise Ni or Ni-alloys. In addition to the WC carbides, other carbides or nitrides may also be present in the cemented carbide e.g. TiC, Cr-carbides, TaC, and/or HfC.

### DETAILED DESCRIPTION

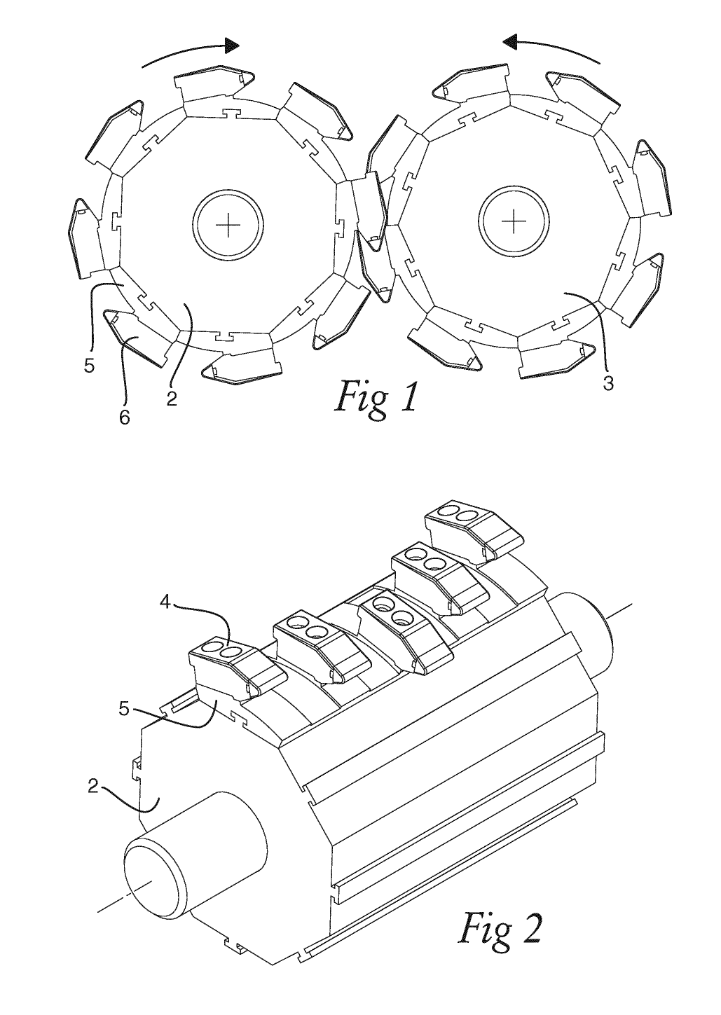

FIG. 1 shows an embodiment of a device for mechanical decomposition of material 1 according to the present disclosure. In this case the device is a crusher. The crusher is primarily aimed for use in a mining plant in which oil sand is treated for the purpose of extracting oil therefrom. However, other similar applications in which the crusher is used for the crushing of particulate matter are off course also envisaged. The crusher 1 comprises a first rotary element 2 and a further second rotary element 3, wherein there is a gap between the first rotary element 2 and the second rotary element 3. On an outer peripheral surface of said rotary elements 2, 3, there are provided wear resistant components 4 according that, upon rotation of the rotary element, will move into said gap with a leading portion first, for the purpose of crushing particulate matter present in said gap. In the embodiment shown in FIG. 1, such particulate matter will be introduced from above. The wear resistant components 4 are attached to elongated holders 5 that are attached to the rotary elements 2, 3 and extend in a longitudinal direction thereof. Each holder 5 carries a plurality of wear resistant components as defined hereinabove or hereinafter and occupies a predetermined segment of the outer periphery of each rotary element 2, 3 respectively.

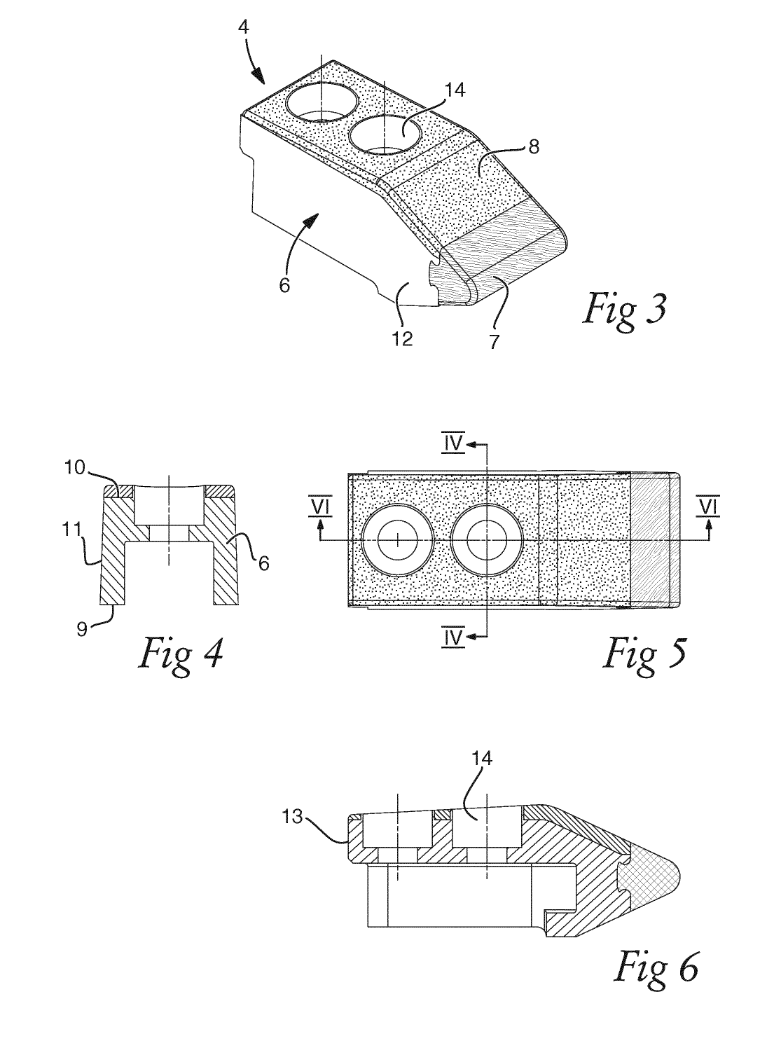

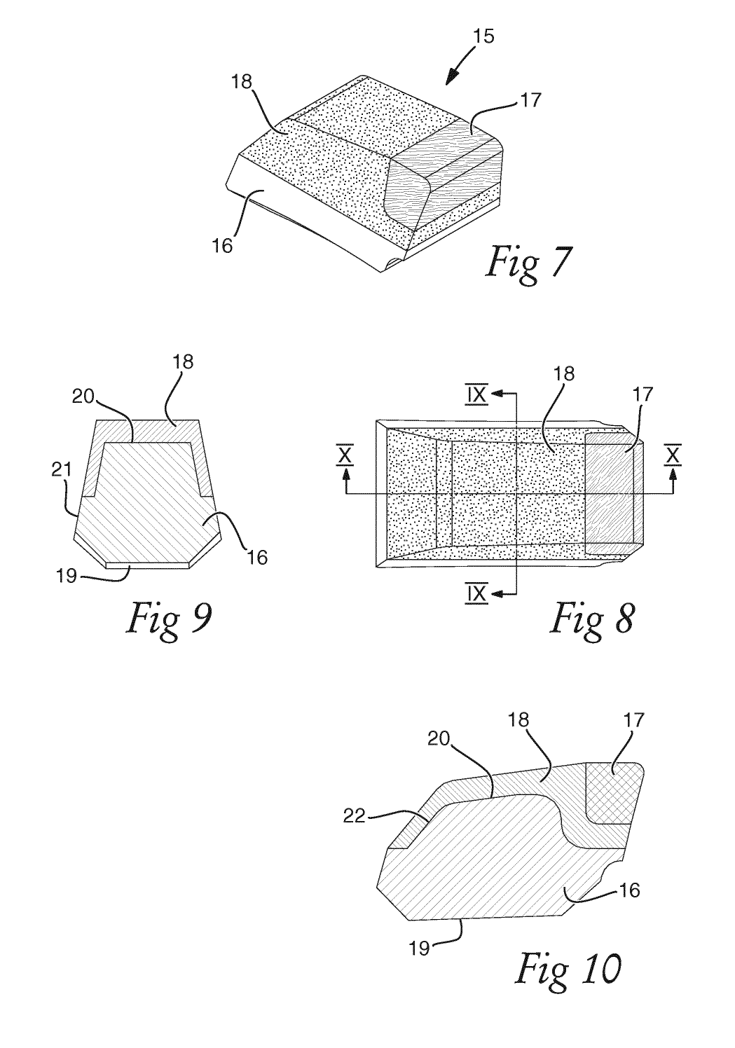

The wear resistant components 4 shown in FIGS. 1 and 2 are shown more in detail in FIGS. 3-6 and are primarily adapted for use in a so called secondary sizer in a plant for the extraction of oil from oil sand. However, the present disclosure is not limited to a crusher provided with these specific wear resistant components but could be provided with any kind of wear resistant component within the scope of the present disclosure, exemplified in FIGS. 7-13. Thereby, the crusher may also be adapted to other applications than the above-mentioned secondary sizer application, such as a primary sizer for the crushing of coarser particulate matter, or a tertiary sizer, for the crushing of finer particulate matter than in the secondary sizer. Different embodiments of wear resistant components aimed from use in a crusher according to the disclosure will be described more in detail hereinafter.

FIGS. 3-6 show a first embodiment of a wear resistant component 4 of the present disclosure. The wear resistant component 4 comprises a steel body 6, a leading portion 7 attached to ta front portion of the steel body 6, and a wear resistant coating 8 of a metal matrix composite attached to at least one face of said steel body 6 in connection to said leading portion 7. The steel body 6 comprises a bottom face 9 aimed to bear on a holder like one of the holders 5 shown in FIG. 1. Opposite to the bottom face 9 the steel body has top face 10. Between the bottom face 9 and the top face 10 there is provided a lateral face 11 on each side of the steel body 6. Accordingly, the steel body 6 comprises two opposite lateral faces 11. At one end of the steel body 6, there is provided a wedge-like front portion 12 at the end of which there is provided the leading portion 7 made of cemented carbide. The leading portion 7 is aimed to be the foremost part of the wear resistant component 4 that hits particulate matter to be crushed by means of the wear resistant component 4. The leading portion 7 is therefore the hardest part of the wear resistant component. In the embodiment shown in FIG. 3-6, the leading portion 7 is attached to the steel body 6 by a shape-locking joint, here defined by a projection of the leading portion 7 engaging a recess in the front portion 12 of the steel body 6. From the leading portion 7 to a rear face 13 of the steel body 6, the top face 10 of the steel body 6 is covered by the wear resistant coating 8. An upper part of the opposite lateral faces 11 are also covered by the wear resistant coating 8. The parts of the steel body 6 that are covered by the wear resistant coating 8 are the parts of said faces 9-11 that are assumed to be most subjected to wear in an application like the one shown in FIGS. 1-2. Possibly, larger parts of the lateral faces 11, or the whole area thereof may be covered with the wear resistant coating 8. Also, the rear face 12 may be covered with the wear resistant coating 8 if deemed to be necessary or advantageous either for the function or for the production of the wear resistant component 4.

The wear resistant coating 8 comprises a metal matrix composite comprised by particles of tungsten carbide and a metal matrix of any one of a nickel-based alloy, a cobalt-based alloy or an iron-based alloy. The wear resistant coating has been formed through consolidation of a powder mixture by means of Hot Isostatic Pressing (HIP). According to one embodiment, the particles of tungsten carbide are distributed as discrete non-interconnecting particles in the matrix of metal-based alloy. Examples of preferred metal matrix alloys will be presented later.

The wear resistant component 4 shown in FIGS. 3-6 comprises holes 14 aimed for bolts (not shown) by means of which the component 4 may be attached to a holder, like the holder 5 shown in FIG. 1. The holes 14 extend from the top face 10 to the bottom face 9 of the steel body 6.

FIGS. 7-10 show an alternative embodiment of a wear resistant component of the disclosure, here indicated with reference numeral 15. The wear resistant component 15 of this embodiment also comprises a steel body 16, a leading portion 17 attached to ta front portion of the steel body 16, and a wear resistant coating 18 of a metal matrix composite attached to at least one face of said steel body 16 in connection to said leading portion 17. As can be seen in FIG. 10, the leading portion 17 is not directly attached to the front portion of the steel body 16 but to a part of the wear resistant coating 17 that covers the front portion of the steel body 16. Such a design is not a necessity. In fact, it might even be preferred to have the leading portion directly attached to the steel body 16. In such a case, the front portion of the steel body 16 should not be covered by the wear resistant coating 18 as shown in FIGS. 7-10.

As in the previous embodiment, the leading portion 17 consists of cemented carbide, and the wear resistant coating 18 comprises a metal matrix composite which in turn comprises particles of tungsten carbide and a metal matrix of any one of a nickel-based alloy, a cobalt-based alloy or an iron-based alloy.

The steel body 16 comprises a bottom face 19 aimed to bear on a holder like one of the holders 5 shown in FIG. 1. Opposite to the bottom face 19 the steel body 16 has top face 20. Between the bottom face 19 and the top face 20 there is provided a lateral face 21 on each side of the steel body 16. Accordingly, the steel body 16 comprises two opposite lateral faces 21. There is also provided a rear face 22 on the steel body 16. The top face 20 is covered by the wear resistant coating 18, as well as an upper part of the rear face 22, adjoining the top face 20. An upper part of each lateral face 21 adjoining the top face 20 is also covered with the wear resistant coating 18. A lower part of the lateral faces 21, neighbouring the bottom face 19, is not covered with the wear resistant coating 18, in order to promote attachment of the wear resistant component 15 to a holder by means of welding.

The wear resistant component 15 shown in FIGS. 7-10 is primarily aimed for use in a so called tertiary sizer in a plant for the extraction of oil from oil sand.

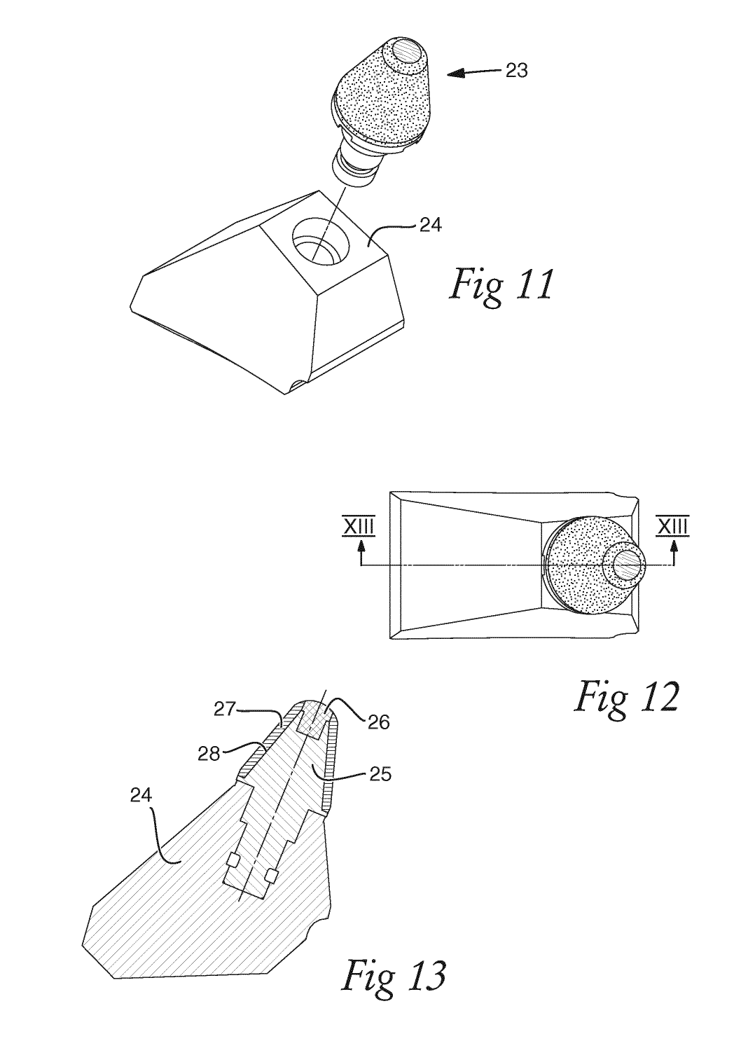

FIGS. 11-13 show a further embodiment of a wear resistant component according to the present disclosure, here indicated with reference numeral 23. A holder 24 is also indicated for the purpose of more clearly showing how the wear resistant component 23 is assumed to be attached to a holder. In order to enable attachment to a wear resistant component designed like the component 23 shown in FIGS. 11-13, the holders 5 shown in FIG. 1 could thus be designed like the holder 23 shown in FIGS. 11-13.

The wear resistant component 23 presents a said steel body 25 that at least partially, in a front portion thereof, has the shape of a truncated cone. The steel body 25 also comprises a rear portion aimed for insertion into and attachment to a holder 24. At a foremost part of the front portion of the steel body 25, there is provided a leading portion 26 forming a nose on said truncated cone. A wear resistant coating 27 of a metal matrix composite is attached to a mantle surface 28 of said truncated cone. When the wear resistant component 23 is inserted into and attached to the holder 24, there are no surfaces of the steel body 25 exposed to the exterior. In other words, all faces of the steel body 25 that are not housed by the holder 24 are covered by the wear resistant coating 27 and the leading portion 26.

The wear resistant component shown in FIGS. 11-13 is primarily aimed for use in a crusher of a primary sizer in a plant for the extraction of oil from oil sand. It is primarily aimed for the crushing of coarser matter than the wear resistant components 4, 15 shown in FIGS. 3-10.

The wear resistant components 4, 15, 23, described with reference to FIGS. 1-13, all have a leading portion 7, 17, 26 comprising cemented carbide, preferably a solid piece of cemented carbide. Preferably, the cemented carbide comprises tungsten carbide and a binder phase, typically a cobalt binder phase. Preferably, the leading portion is connected directly to the steel body, but it may, as an alternative, be attached to a wear resistant coating applied onto the steel body.

The wear resistant coating 8, 18, 27 is formed and attached to the steel body 6, 16, 25 by means of Hot Isostatic Pressing, wherein a powder mixture comprising the constituents of the wear resistant coating is arranged on the face or faces of the steel body 6, 16, 27 which are to be covered by the coating and encapsulated in that position, for example by means of a glass encapsulation or a metal encapsulation, wherein the steel body and the encapsulation forms a mould in which the powder mixture is housed. Thereafter, temperature and pressure is increased in a heatable pressure chamber, normally referred to as a Hot Isostatic Pressing-chamber (HIP-chamber) in accordance with a predetermined HIP cycle. The elevated temperature and pressure applied, as well as the duration of the application of elevated temperature and pressure is adapted to the specific composition and possible other relevant features, such as particle size and geometry, and amount of the powder mixture to be consolidated.

The heating chamber is pressurized with gas, e.g. argon gas, to an isostatic pressure in excess of 500 bar. Typically the isostatic pressure is 900-1200 bar. The chamber is heated to a temperature below the melting point of the metal-based alloy powder. The closer to the melting point the temperature is, the higher is the risk for the formation of melted phase and unwanted streaks of brittle carbide networks. Therefore, the temperature should be as low as possible in the furnace during HIP:ing. However, at low temperatures the diffusion process slows down and the material will contain residual porosity and the metallurgical bond between the particles becomes weak. Therefore, the temperature is preferably 100-200° C. below the melting point of the metal-based alloy, for example 900-1150° C., or 1000-1150° C. for a cobalt-based or nickel-based alloy. The filled mould is held in the heating chamber at the predetermined pressure and the predetermined temperature for a predetermined time period. The diffusion processes taking place between the powder particles during HIP:ing are time dependent so long times are preferred. However, too long times could lead to excessive WC dissolution. Preferable, the form should be HIP:ed for a time period of 0.5-3 hours, such as 1-2 hours, such as 1 hour.

During HIP:ing, the particles of the metal-based alloy powder will deform plastically and bond metallurgically through various diffusion processes to each other and the tungsten particles so that a dense, coherent component of diffusion bonded metal-based alloy particles and tungsten carbide particles is formed. In metallurgic bonding, metallic surfaces bond together flawlessly with an interface free of defects such as oxides, inclusions or other contaminants.

After consolidation of the powder mixture, possible parts of the encapsulation that are not wanted on the finally produced wear resisting component are removed from the wear resistant component with its wear resistant coating.

In a powder mixture for HIP:ing, a wear resistant coating according to the present disclosure, the amounts of the included powders are selected such that a first, WC powder constitutes 30-70 vol % of the total volume of the powder mixture and a second, metal-based alloy, powder constitutes 70-30 vol % of the total volume of the powder mixture. For example, if 30 vol % of the total volume of the powder mixture is constituted by WC, the remainder is 70 vol % metal-based alloy powder WC powder. By “WC” is meant either pure tungsten carbide or cast eutectic carbide (WC/W2C). The use of macro crystalline, pure, WC as opposed to the eutectic WC/W₂C carbide, is preferred. The WC phase of tungsten carbide resists dissolution much better than W₂C. The eutectic tungsten carbide consists of 80-90 vol % W₂C and is therefore much more sensitive to dissolution than pure tungsten carbide.

The metal-based matrix composite forming the wear resistant coating 8, 18, 27 on the steel body 6, 16, 25 of the wear resistant component 4, 14, 23 is a nickel-based metal matrix composite or a cobalt-based metal matrix composite, or an iron-based metal matrix composite. The particles of tungsten carbide may be distributed as discrete non-interconnecting particles in the matrix of metal-based alloy.

### Nickel-Based Metal Matrix Composites

Examples of suitable compositions (in weight %) of a nickel-based alloy within the scope of the present disclosure and suitable for consolidation by means of HIP are:

C: 0.1; Si: 2.3; B: 1.25; Fe 1.25; balance Ni and unavoidable impurities.
C: 0.1; Si: 2.3; B: 1.75; Fe 1.25; balance Ni and unavoidable impurities.
C: 0.1; Si: 3.2; B: 1.25; Fe 1.25; balance Ni and unavoidable impurities.
C: 0.25; Cr: 5.0; Si: 3.25; B: 1.25; Fe: 1.0; balance Ni and unavoidable impurities.
C: 0.35; Cr: 8.5; Si: 2.5; B: 1.25; Fe: 1.0; balance Ni and unavoidable impurities.
C: 0.35; Cr: 9.5; Si: 3.0; B: 2.0; Fe: 3.0; balance Ni and unavoidable impurities.
C: 0.5; Cr: 11.5; Si: 4.0; B: 2.5; Fe: 3.0; balance Ni and unavoidable impurities.
C: 0.75; Cr: 14.0; Si: 4.0; B: 2.0; Fe: 4.5; balance Ni and unavoidable impurities.

The nickel-based alloy particles have a substantially spherical shape, alternatively a deformed spherical shape. An increased content of alloying elements will result in a harder and more brittle material. The above-mentioned examples range from a hardness (Rc) of approximately 14 to a hardness (Rc) of approximately 62. Hardness of the metal alloy is to a certain degree an important property for obtaining a wear resistant metal matrix composite. However, certain ductility is also a requested property of the alloy since this makes the metal matrix composite less prone to cracking. A metal matrix composite that is not prone to cracking has been proven to have a better wear resistance than a corresponding metal matrix composite being more prone to cracking.

In the case of a nickel-based metal matrix composite, a nickel-based alloy having a hardness (Rc) in the range of 30-40, preferably 33-37, has proven to be particularly advantageous while resulting in a sufficiently hard and yet ductile metal matrix composite. Among the above-mentioned examples of possible nickel-based alloys within the scope of the present disclosure, the following composition (in weight %) has proven to result in a metal matrix composite with very good wear resistant properties due to its combination of hardness and ductility, and is therefore preferred:

| | |
|---|---|
| 0.35 | C |
| 8.5 | Cr |
| 2.5 | Si |
| 1.8 | B |
| 2.5 | Fe |

Balance Ni and unavoidable impurities.

In order to generate said metal matrix composite, a powder of the above-mentioned composition with a particle size of d90=22 μm is used in a powder mixture to be HIP:ed, i.e 90% of the powder particles have a size less than 22 μm.

The preferred tungsten carbide has a particle size in the range of 105-250 μm. A metal matrix composite with approximately 50 vol. % tungsten carbide is preferred. This corresponds to approximately 67 wt % tungsten carbide. Accordingly, the wear resistant coating is formed by a metal matrix composite in which 33 wt % is metal matrix and 67 wt % is tungsten carbide.

### Cobalt-Based Metal Matrix Composites

As an alternative to a nickel-based metal matrix composite, a cobalt-based metal matrix composite may be used as the wear resistant coating. The main advantage of using cobalt-based alloys in a metal matrix composite is that these alloys have low stacking fault energy which leads to a suitable deformation hardening behaviour of the alloy. This is, without being bond to any theory, believed to be one reason for cobalt-based alloys good resistance to erosion at high impinging angles of the erosive media.

According to one embodiment, the metal matrix composite comprises particles of tungsten carbide and a matrix of a cobalt-based alloy, wherein the cobalt-based alloy consists of: 20-35 wt % Cr, 0-20 wt % W, 0-15 wt % Mo, 0-10 wt % Fe, 0-5 Ni wt %, 0.05-4 wt % C and balance Co and unavoidable impurities. Chromium is added for corrosion resistance and to ensure that hard chromium carbides are formed by reaction with the carbon in the alloy. Also tungsten and/or molybdenum are may be included in the cobalt based alloy for carbide formation and solid solution strengthening. The carbides, i.e. chromium carbides, tungsten carbides and/or molybdenum rich carbides will increase the hardness of the ductile cobalt phase and thereby its wear resistance. However, too high amounts of the alloy elements Cr, W and Mo may lead to excessive amounts of carbide precipitation which will reduce the ductility of the metal matrix. Iron is added to stabilize the FCC crystal structure of the alloy and thus increases the deformation resistance of the alloy. However, too high amounts of iron may affect mechanical, corrosive and tribological properties negatively.

According to a further embodiment, the cobalt-based alloy may comprise 27-32 wt % Cr, 0-2 wt % W, 4-9 wt % Mo, 0-2 wt % Fe, 2-4 wt % Ni, 0,1-1.7 wt % C and balance Co.

According to an alternative embodiment, the cobalt-based alloy may comprise: 26-30 wt % Cr, 4-8 wt % Mo, 0-8 wt % W, 0-4 wt % Ni, 0-1.7 wt % C and balance Co.

According to yet another embodiment, the cobalt-based alloy may comprise: 26-29 wt % Cr, 4.5-6 wt % Mo, 2-3 wt % Ni, 0.20-0.35 wt % C and balance Co.

For the enablement of the present disclosure, a preferred metal matrix composite comprises approximately 50 vol % WC particles and 50 vol % of a cobalt-based alloy having a composition of: 26-29 wt % Cr, 4,5-6 wt % Mo, and 0,2-0,35% C and balance Co and unavoidable impurities. This composition will be consolidated by means of HIP. Thereby, a WC-powder having a mean size of 100-200 μm and a cobalt-based alloy powder having a mean size of 45-95 μm may preferably form a powder mixture to be consolidated by means of HIP.

### Iron-Based Metal Matrix Composites

As an alternative to a nickel-based or a cobalt-based metal matrix composite, an iron-based metal matrix composite may be used as the wear resistant coating. Preferably, the iron-based alloy comprises, in weight %: 0,5-3 wt % C; 0-30 wt % Cr; 0-3 wt % Si; 0-10 wt % Mo; 0-10 wt % W; 0-10 wt % Co; 0-15 wt % V; 0-2 wt % Mn; balance Fe and unavoidable impurities. According to a preferred embodiment, the iron-based alloy comprises, in weight %: 1-2.9 wt % C; 4-25 wt % Cr; 0,3-1.5 wt % Si; 4-8 wt % Mo; 4-8 wt % W; 0-8 wt % Co; 3-15 wt % V; 0,4-1.5 wt % Mn; balance Fe and unavoidable impurities.

For the enablement of the disclosure, a preferred iron-based metal matrix composite comprises approximately 50 vol % WC particles and 50 vol % of an iron-based alloy having a composition of: in weight %: 1,9-2.1 wt % C; 26 wt % Cr; 0,6-0.8 wt % Si; 0,4-0.6 wt % Mn remainder Fe and unavoidable impurities. This composition is consolidated by means of HIP. Thereby, a WC-powder having a mean size of 100-200 μm and an iron-based alloy powder having a mean size of 45-95 μm may preferably form a powder mixture to be consolidated by means of HIP.

1. A wear resistant component for comminution of particulate material, comprising:
a steel body having a front portion and a leading portion of cemented carbide attached to the front portion of said steel body; and
a wear resistant coating of a metal matrix composite attached to at least one face of said steel body connected to said leading portion, wherein the wear resistant coating is formed by consolidation of a powder mixture and by metallurgically bonding said powder mixture to the steel body by means of Hot Isostatic Pressing.

2. A wear resistant component according to claim 1, wherein said metal matrix composite is selected from a nickel-based metal matrix composite, a cobalt-based metal matrix composite, and an iron-based metal matrix composite.

3. A wear resistant component according to claim 1, wherein particles of tungsten carbide are distributed as discrete non-interconnecting particles in the matrix of metal-based alloy.

4. A wear resistant component according to claim 1, wherein said metal matrix composite includes particles of tungsten carbide and a matrix of a nickel-based alloy, wherein the nickel-based alloy consists of: 0-1.0 wt % C; 5-14.0 wt % Cr; 0.5-4.5 wt % Si; 1.25-3.0 wt % B; 1.0-4.5 wt % Fe; balance Ni and unavoidable impurities.

5. A wear resistant component according to claim 1, wherein the metal matrix composite includes particles of tungsten carbide and a matrix of a cobalt-based alloy, wherein the cobalt-based alloy consists of: 20-35 wt % Cr, wt % W, 0-15 wt % Mo, wt % Fe, 0-5 Ni, 0.05-4 wt % C and balance Co and unavoidable impurities.

6. A wear resistant component according to claim 1, wherein the metal matrix composite includes particles of tungsten carbide and a matrix of a cobalt-based alloy, wherein the cobalt-based alloy comprises: 26-29 wt % Cr, 4.5-6 wt % Mo, 0.20-0.35 wt % C, 2-3 wt % Ni, and balance Co and unavoidable impurities.

7. A wear resistant component according to claim 1, wherein the metal matrix composite includes particles of tungsten carbide and a matrix of an iron-based alloy, wherein the iron-based alloy consists of: 0,5-3 wt % C; wt % Cr; 0-3 wt % Si; wt % Mo; wt % W; wt % Co; 0-15 wt % V; 0-2 wt % Mn; balance Fe and unavoidable impurities

8. A wear resistant component according to claim 1, wherein said leading portion has a tapering cross-section and forms a tip or edge at said front portion of the steel body.

9. A wear resistant component according to claim 1, wherein said steel body includes a bottom face and a top face opposite said bottom face, said wear resistant coating of the metal matrix composite being attached to said top face.

10. A wear resistant component according to claim 9, wherein, between said bottom face and said top face, said steel body includes opposing lateral faces, said wear resistant coating of the metal matrix composite being attached to at least parts of said lateral faces.

11. A wear resistant component according to claim 8, wherein said steel body has the shape of a truncated cone, said leading portion forming a nose on said truncated cone and said face being a mantle surface of said truncated cone, and the wear resistant coating of a metal matrix composite being attached to at least parts of said mantle surface.

12. A wear resistant component according to claim 1, wherein the wear resistant component is selected from an impact hammer; a roll crusher tooth; a crusher tooth for secondary and/or tertiary crushers; a wear segment for crushers; a wear plate for crushers; and a component for a slurry handling system.

13. A device for mechanical decomposition of material comprising a wear resistant component according to claim 1.

14. A device for mechanical decomposition of material according to claim 13, further comprising at least a first rotary element and a second element, wherein there is a gap between the first rotary element and said second element, wherein at least one wear resistant component is disposed on an outer peripheral surface of said first rotary element, such that, upon rotation of the first rotary element, the at least one wear resistant component is arranged to move into said gap with its leading portion, first to mechanically decompose particulate matter present in said gap.

15. A device for mechanical decomposition of material according to claim 14, wherein the second element is a second rotary element and that on an outer peripheral surface of said second rotary element, there is provided at least one wear resistant component, and that, upon rotation of the second rotary element, the wear resistant component thereon is arranged to move into said gap with its leading portion first, to mechanically decompose particulate matter present in said gap.
